(19) United States
(12) Patent Application Publication
(10) Pub. No.: US 2026/0024700 A1
(43) Pub. Date: Jan. 22, 2026

(54) MULTILAYER CERAMIC CAPACITOR

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 19/341,490

(22) Filed: Sep. 26, 2025

Related U.S. Application Data
(63) Continuation of application No. PCT/JP2024/013796, filed on Apr. 3, 2024.

(30) Foreign Application Priority Data
Jun. 27, 2023 (JP) 2023-105036

(51) Int. Cl. H01G 4/012; H01G 4/008; H01G 4/232; H01G 4/248; H01G 4/30

(52) U.S. Cl. CPC H01G 4/012; H01G 4/008; H01G 4/2325; H01G 4/248; H01G 4/30

(57) ABSTRACT

A multilayer ceramic capacitor includes a laminate including first and second surfaces facing each other in a lamination direction, third and fourth surfaces facing each other in a first direction, and fifth and sixth surfaces facing each other in a second direction, a first external electrode on the third surface, a second external electrode on the fourth surface, a third external electrode on the fifth surface, and a fourth external electrode on the sixth surface, an internal layer portion and two outer layer portions. The inner layer portion includes an inner layer dielectric layer, a first internal electrode exposed on the third and second surfaces, and a second internal electrode exposed on the fifth and sixth surfaces. The second internal electrode includes first and second regions. In the lamination direction, a thickness of the second region is less than a thickness of the first region.

### CROSS REFERENCE TO RELATED APPLICATIONS

This application claims the benefit of priority to Japanese Patent Application No. 2023-105036, filed on Jun. 27, 2023 and is a Continuation Application of PCT Application No. PCT/JP2024/013796 filed on Apr. 3, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, electronic devices have been increasingly miniaturized. In addition, the number of electronic components incorporated in an electronic device is increasing. In particular, a multilayer ceramic capacitor such as a three-terminal feedthrough capacitor disclosed in Japanese Unexamined Patent Application, Publication No. 2005-44871 has excellent low impedance characteristics in a high frequency band so that a low impedance circuit can be designed by increasing the number of multilayer ceramic capacitors (the number of capacitors connected in parallel).

However, an increase in the number of multilayer ceramic capacitors forming a circuit may give rise to a disadvantage that a failure of one of the multilayer ceramic capacitors leads to a failure of the circuit. For this reason, it is necessary to improve the reliability of the multilayer ceramic capacitor. In particular, when moisture infiltrates into the multilayer ceramic capacitor, insulation resistance may deteriorate.

### SUMMARY OF THE INVENTION

Example embodiments of the present invention provide multilayer ceramic capacitors each able to reduce a likelihood of deterioration of insulation resistance due to moisture infiltration.

A multilayer ceramic capacitor according to an example embodiment of the present invention includes a multilayer body including a first surface and a second surface opposed to each other in a lamination direction, a third surface and a fourth surface opposed to each other in a first direction orthogonal or substantially orthogonal to the lamination direction, and a fifth surface and a sixth surface opposed to each other in a second direction orthogonal or substantially orthogonal to the lamination direction and the first direction, a first external electrode on the third surface of the multilayer body, a second external electrode on the fourth surface of the multilayer body, a third external electrode on the fifth surface of the multilayer body, and a fourth external electrode on the sixth surface of the multilayer body. The multilayer body includes an inner layer portion, and two outer layer portions sandwiching the inner layer portion in the lamination direction. The inner layer portion includes an inner dielectric layer, a first internal electrode including ends in the first direction exposed at the third surface and the fourth surface, respectively, and a second internal electrode including ends in the second direction exposed at the fifth surface and the sixth surface, respectively. The second internal electrode includes a first region located inside the multilayer body, and second regions extending from the first region toward the fifth surface and the sixth surface, respectively. The second regions are thinner in the lamination direction than the first region.

Due to the second internal electrode including the first region located inside the multilayer body and the second regions extending from the first region toward the fifth and sixth surfaces, respectively, and the second regions are thinner in the lamination direction than the first region, multilayer ceramic capacitors according to example embodiments of the present invention each reduce the likelihood of moisture filtration from an outer periphery of the second internal electrode and reduce the likelihood of deterioration of insulation resistance due to moisture filtration.

Example embodiments of the present invention provide multilayer ceramic capacitors each able to reduce a likelihood of deterioration of insulation resistance due to moisture infiltration.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating a multilayer ceramic capacitor according to an example embodiment of the present invention.

FIG. 2 is a front view illustrating a multilayer ceramic capacitor according to an example embodiment of the present invention.

FIG. 3 is a top view illustrating a multilayer ceramic capacitor according to an example embodiment of the present invention.

FIG. 4 is a cross-sectional view taken along line IV-IV in FIG. 1.

FIG. 5 is a cross-sectional view taken along line V-V in FIG. 1.

FIG. 6 is a cross-sectional view taken along line VI-VI in FIG. 4.

FIG. 7 is a cross-sectional view taken along line VII-VII in FIG. 4.

FIG. 8 is an enlarged view of a portion A in FIG. 5.

### DETAILED DESCRIPTION OF THE EXAMPLE EMBODIMENTS

Example embodiments of the present invention will be described in detail below with reference to the drawings.

### 1. Multilayer Ceramic Capacitor

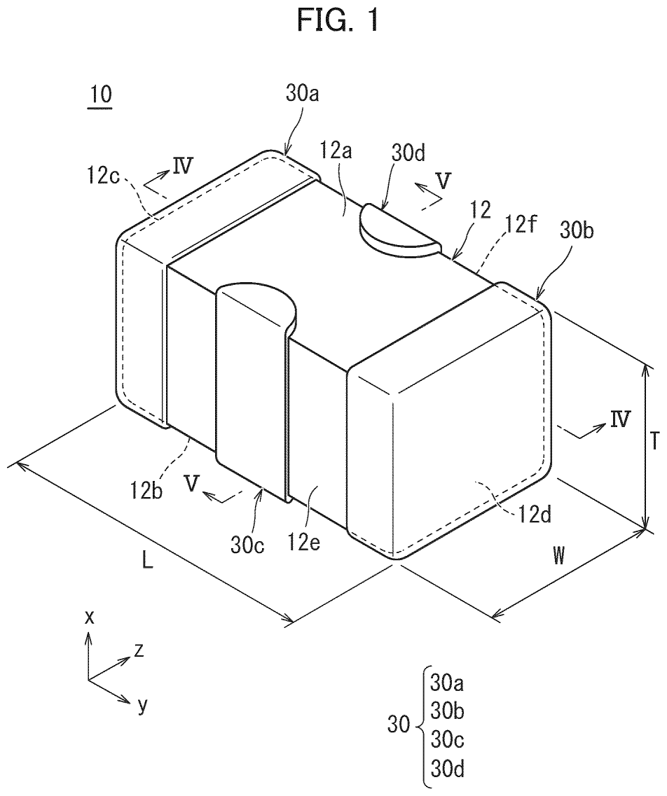

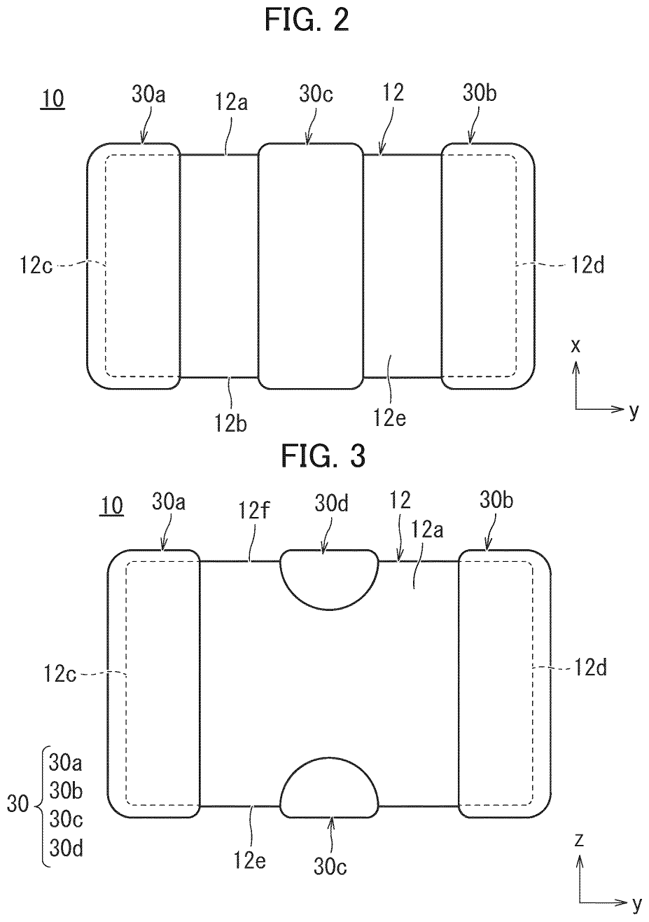

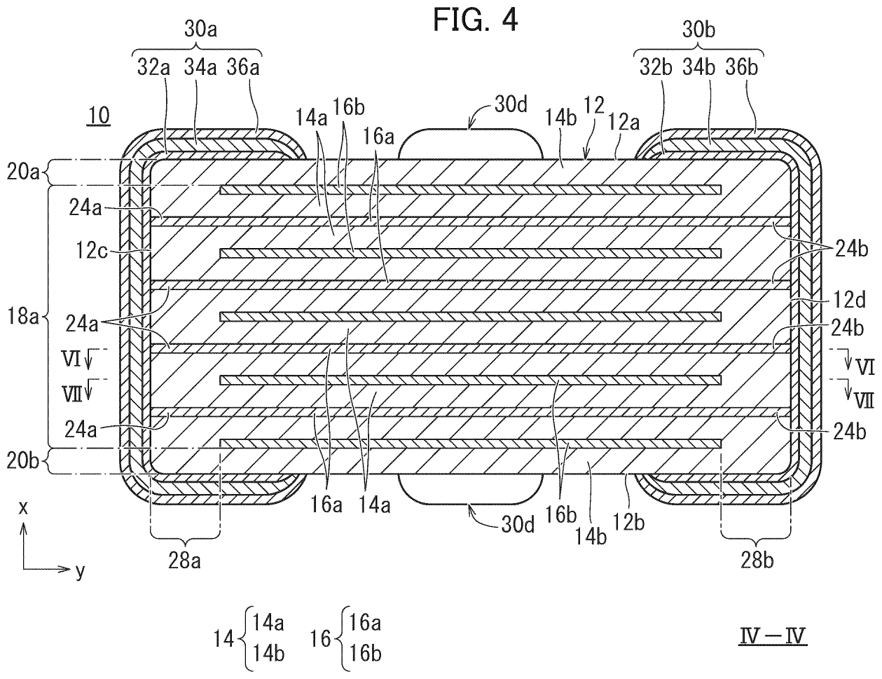

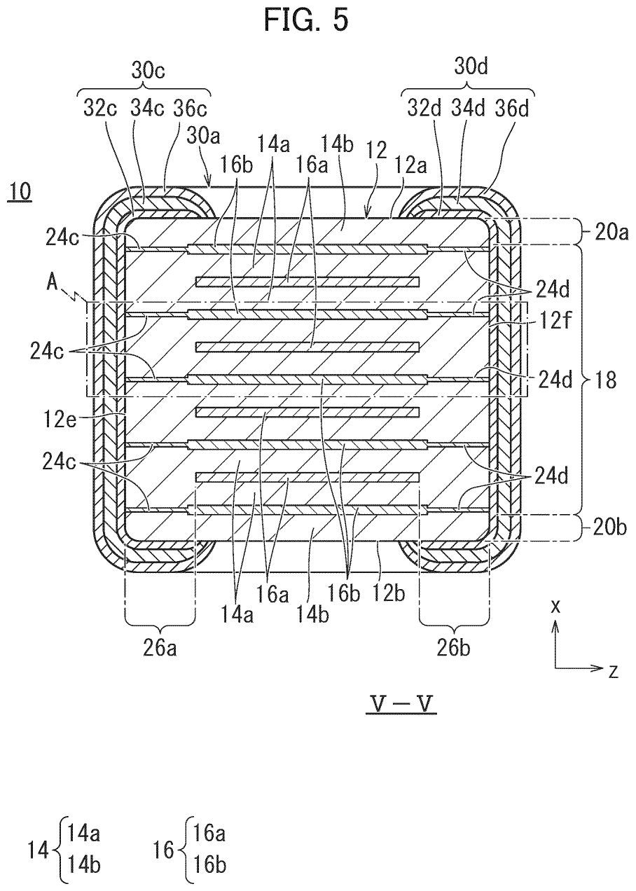

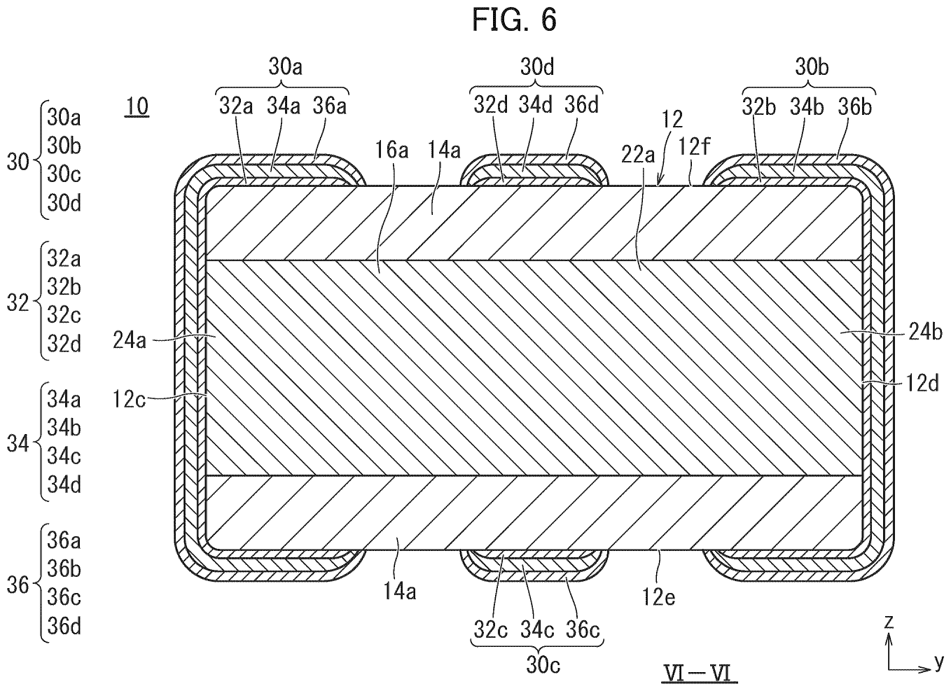

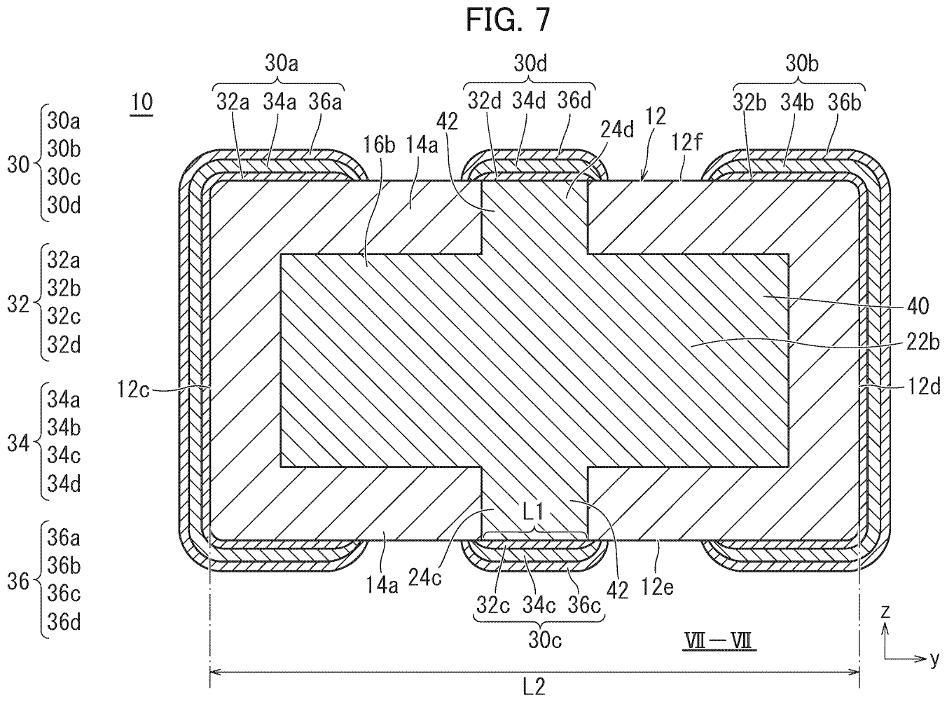

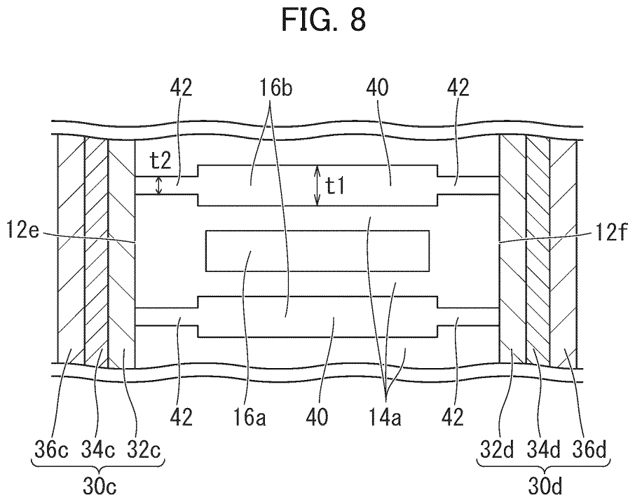

A multilayer ceramic capacitor 10 according to an example embodiment of the present invention will be described below. FIG. 1 is an external perspective view illustrating the multilayer ceramic capacitor according to the present example embodiment. FIG. 2 is a front view illustrating the multilayer ceramic capacitor according to the present example embodiment. FIG. 3 is a top view illustrating the multilayer ceramic capacitor according to the present example embodiment. FIG. 4 is a cross-sectional view taken along line IV-IV in FIG. 1. FIG. 5 is a cross-sectional view taken along line V-V in FIG. 1. FIG. 6 is a cross-sectional view taken along line VI-VI in FIG. 4. FIG. 7 is a cross-sectional view taken along line VII-VII in FIG. 4. FIG. 8 is an enlarged view of a portion A in FIG. 5.

The multilayer ceramic capacitor 10 includes a multilayer body 12 and a plurality of external electrodes 30.

The multilayer body 12 includes a first surface 12a and a second surface 12b opposed to each other in a lamination direction x, a third surface 12c and a fourth surface 12d opposed to each other in a first direction y orthogonal or substantially orthogonal to the lamination direction x, and a fifth surface 12e and a sixth surface 12f opposed to each other in a second direction z orthogonal or substantially orthogonal to the lamination direction x and the first direction y. The lamination direction x connects the first surface 12a and the second surface 12b of the multilayer body 12 to each other.

The multilayer body 12 has a rectangular or substantially rectangular parallelepiped shape. The multilayer body 12 preferably has rounded corners and ridges. Here, the corner is a portion where three adjacent surfaces of the multilayer body 12 meet each other, and the ridge is a portion where two adjacent surfaces of the multilayer body 12 meet each other. The first surface 12a, the second surface 12b, the third surface 12c, the fourth surface 12d, the fifth surface 12e, and the sixth surface 12f may each include unevenness or the like in a portion or the entirety thereof.

The multilayer body 12 includes a plurality of dielectric layers 14 and a plurality of internal electrodes 16. The dielectric layers 14 include inner dielectric layers 14a and outer dielectric layers 14b. The internal electrodes 16 include first internal electrodes 16a and second internal electrodes 16b.

The multilayer body 12 includes an inner layer portion 18, a first main surface-side outer layer portion 20a located adjacent to the first surface 12a, and a second main surface-side outer layer portion 20b located adjacent to the second surface 12b.

The first main surface-side outer layer portion 20a is an aggregate of two or more outer dielectric layers 14b that are located adjacent to the first surface 12a of the multilayer body 12 and sandwiched between the first surface 12a and the internal electrode 16 closest to the first surface 12a.

The second main surface-side outer layer portion 20b is an aggregate of two or more outer dielectric layers 14b that are located adjacent to the second surface 12b of the multilayer body 12 and sandwiched between the second surface 12b and the internal electrode 16 closest to the second surface 12b.

The inner layer portion 18 is sandwiched between the first main surface-side outer layer portion 20a and the second main surface-side outer layer portion 20b.

The inner layer portion 18 includes the first internal electrodes 16a each including one end exposed at the third surface 12c and another end exposed at the fourth surface 12d, second internal electrodes 16b each including one end exposed at the fifth surface 12e and another end exposed at the sixth surface 12f, and the inner dielectric layers 14a.

The dielectric layers 14 can be made of, for example, a dielectric material. Examples of the dielectric material include a dielectric ceramic including, as a main component, BaTiO₃, CaTiO₃, SrTiO₃, CaZrO₃, etc. Alternatively, a material obtained by adding a subcomponent such as, for example, a Mn compound, an Fe compound, a Cr compound, a Co compound, or a Ni compound to the main component may be used. The inner dielectric layers 14a and the outer dielectric layers 14b may be made of the same dielectric material or different dielectric materials.

For example, in a case where the inner dielectric layers 14a include a large amount of CaTiO₃ or CaZrO₃ as a dielectric component, dielectric breakdown is less likely to occur between the first internal electrode 16a and the second internal electrode 16b. The inner dielectric layers 14a may include, for example, SrTiO₃ or the like as a main component, without being limited to the foregoing materials. Alternatively, in order to increase the capacitance of the multilayer ceramic capacitor 10, it is preferable that the inner dielectric layers 14a includes a material having a high permittivity, such as, for example, BaTiO₃ or the like.

Although any number of dielectric layers 14 may be laminated without particular limitation, it is preferable to laminate, for example, five or more and 1000 or less dielectric layers 14, inclusive of the dielectric layers 14 forming the first main surface-side outer layer portion 20a and the second main surface-side outer layer portion 20b. Each dielectric layer 14 preferably has a thickness of, for example, about 0.3 μm or greater and about 6.0 μm or less.

### Internal Electrode

The internal electrodes 16 include the first internal electrodes 16a and the second internal electrodes 16b.

The first internal electrodes 16a are disposed on surfaces of the inner dielectric layers 14a. Each first internal electrode 16a includes a first counter electrode portion 22a located inside the multilayer body 12, a first extension electrode portion 24a connected to the first counter electrode portion 22a and extending toward the third surface 12c, and a second extension electrode portion 24b connected to the first counter electrode portion 22a and extending toward the fourth surface 12d.

The first counter electrode portion 22a of the first internal electrode 16a may have any shape without particular limitation, but it preferably has a rectangular or substantially rectangular shape in plan view. However, its corners may be rounded in plan view, or its corners may have an oblique shape in plan view (tapered shape). Alternatively, the first counter electrode portion 22a may have a tapered shape in plan view which is inclined toward either side.

The first extension electrode portion 24a and the second extension electrode portion 24b of the first internal electrode 16a may have any shape without particular limitation, but they preferably have a rectangular or substantially rectangular shape in plan view. However, their corners may be rounded in plan view, or their corners may have an oblique shape in plan view (tapered shape). Alternatively, the first extension electrode portion 24a and the second extension electrode portion 24b may have a tapered shape in plan view which is inclined toward either side.

The second internal electrodes 16b are disposed on surfaces of the inner dielectric layers 14a, which are not the inner dielectric layers 14a on which the first internal electrodes 16a are disposed. Each second internal electrode 16b includes a second counter electrode portion 22b facing the first internal electrodes 16a, a third extension electrode portion 24c connected to the second counter electrode portion 22b and extending toward the fifth surface 12e, and a fourth extension electrode portion 24d connected to the second counter electrode portion 22b and extending toward the sixth surface 12f.

The second counter electrode portion 22b of the second internal electrode 16b may have any shape without particular limitation, but it preferably has a rectangular or substantially rectangular shape in plan view. However, its corners may be rounded in plan view, or its corners may have an oblique shape in plan view (tapered shape). Alternatively, the second counter electrode portion 22b may have a tapered shape in plan view which is inclined toward either side.

The third extension electrode portion 24c and the fourth extension electrode portion 24d of the second internal electrode 16b may have any shape without particular limitation, but they preferably have a rectangular or substantially rectangular shape in plan view. However, their corners may be rounded in plan view, or their corners may have an oblique shape in plan view (tapered shape). Alternatively, the third extension electrode portion 24c and the fourth extension electrode portion 24d may have a tapered shape in plan view which is inclined toward either side.

The multilayer body 12 includes side portions (W-gaps) 26a and 26b. The side portion (W-gap) 26a is located between the fifth surface 12e and one end in the second direction z of the first counter electrode portion 22a of each first internal electrode 16a and between the fifth surface 12e and one end in the second direction z of the second counter electrode portion 22b of each second internal electrode 16b, and includes the third extension electrode portions 24c of the second internal electrodes 16b. The side portion (W-gap) 26b is located between the sixth surface 12f and one end in the second direction z of the first counter electrode portion 22a of each first internal electrode 16a and between the sixth surface 12f and one end in the second direction z of the second counter electrode portion 22b of each second internal electrode 16b, and includes the fourth extension electrode portions 24d of the second internal electrodes 16b.

The multilayer body 12 further includes end portions (L-gaps) 28a and 28b. The end portion (L-gap) 28a is located between the third surface 12c and one end in the first direction y of the first counter electrode portion 22a of each first internal electrode 16a and between the third surface 12c and one end in the first direction y of the second counter electrode portion 22b of each second internal electrode 16b, and includes the first extension electrode portions 24a of the first internal electrodes 16a. The end portion (L-gap) 28b is located between the fourth surface 12d and one end in the first direction y of the first counter electrode portion 22a of each first internal electrode 16a and between the fourth surface 12d and one end in the first direction y of the second counter electrode portion 22b of each second internal electrode 16b, and includes the second extension electrode portions 24b of the first internal electrodes 16a.

For each second internal electrode 16b, the second counter electrode portion 22b is defined as a first region 40, and the third extension electrode portion 24c and the fourth extension electrode portion 24d are each defined as a second region 42. In other words, the first region 40 of each second internal electrode 16b is a region located inside the multilayer body 12. The second regions 42 of each second internal electrode 16b extend from the first region 40 toward the fifth surface 12e and the sixth surface 12f, respectively.

In the second internal electrode 16b, the first region 40 has a thickness (t1) in the lamination direction x, the second regions 42 have a thickness (t2) in the lamination direction x, and the thickness (t1) and the thickness (t2) are different from each other. More specifically, as illustrated in FIG. 8, the thickness (t2) in the lamination direction x of the second regions 42 is smaller than the thickness (t1) in the lamination direction x of the first region 40. Due to this configuration, the second regions 42 are exposed in a reduced area at the fifth surface 12e and the sixth surface 12f of the multilayer body 12. As a result, paths that may allow moisture infiltration are reduced, thereby making it possible to improve the moisture resistance. In this configuration, each second region 42 may be thin in its entirety or only in a portion exposed at the fifth surface 12e or the sixth surface 12f.

When the thickness in the lamination direction x of the first region 40 is defined as t1, and the thickness in the lamination direction x of the second regions 42 exposed at the fifth surface 12e and the sixth surface 12f is defined as t2, for example, the following relationship is preferably satisfied: about 0.2t1≤t2≤about 0.8t1. This range makes it possible to reduce the likelihood of deterioration of the insulation resistance due to moisture infiltration, while reducing the likelihood of a decrease in capacitance due to contact failure. Here, in a case where t2 is less than about 0.2t1, there is a possibility that the second internal electrodes 16b cannot be connected to a third external electrode 30c and a fourth external electrode 30d. On the other hand, in a case where t2 is greater than about 0.8t1, moisture may infiltrate from a portion of the second internal electrodes 16b.

Here, the thickness in the lamination direction x of the second regions 42 can be measured by, for example, the following method. First, the side portions (W-gaps) 26a and 26b of the multilayer body 12 are polished up to about one half of their length in the second direction z. On the polished cross sections, the second regions 42 are observed using a scanning microscope (SEM). An average of the thicknesses of any five layers of the second regions 42 consecutive in the lamination direction x is defined as the thickness in the lamination direction x of the second regions 42. Alternatively, the side portions (W-gaps) 26a and 26b of the multilayer body 12 may be polished up to one third of their length in the second direction z. The thickness in the lamination direction x of the first region 40 can be measured, for example, by the following method. First, the multilayer body 12 is polished up to one half of its length in the second direction z. On the polished cross section, the first regions 40 are observed using a scanning microscope (SEM). An average of the thicknesses of any five layers of the first regions 40 consecutive in the lamination direction x is defined as the thickness in the lamination direction x of the first region 40.

When the length in the first direction y of a portion of the second region 42 exposed at the fifth surface 12e and the length in the first direction y of a portion of the second region 42 exposed at the sixth surface 12f are defined as Li, and the length in the first direction y of the multilayer body 12 is defined as L2, the following relationship is, for example, preferably satisfied: about 0.02L2<L1<about 0.20L2. This range makes it possible to reduce the likelihood of deterioration of the insulation resistance due to moisture infiltration, while reducing the likelihood of a decrease in capacitance due to contact failure. In a case where Li is about 0.02L2 or less, there is a possibility that the second internal electrodes 16b cannot be connected to the third external electrode 30c and the fourth external electrode 30d. On the other hand, in a case where Li is about 0.20L2 or greater, there is a possibility that a portion of the second internal electrodes 16b are not covered with the third external electrode 30c or the fourth external electrode 30d, thus allowing moisture infiltration.

Examples of a material of the first internal electrodes 16a and the second internal electrodes 16b include, but are not limited to, a metal such as Ni, Cu, Ag, Pd, Au, etc., and an appropriate conductive material such as an alloy including at least one of the foregoing metals (e.g., a Ni—Cu alloy, a Ag—Pd alloy, etc.). The first internal electrodes 16a and the second internal electrodes 16b may be made of the same conductive material or different conductive materials.

When the first internal electrodes 16a and the second internal electrodes 16b include, for example, Sn, it is possible to relax electric field concentration on the interface between the internal electrode 16 and the dielectric layer 14, thus contributing to improvement in high-temperature load reliability. This advantageous effect can be sufficiently obtained even in a case where only the first internal electrodes 16a or the second internal electrodes 16b include Sn.

The total number of the first internal electrodes 16a and the second internal electrodes 16b is, for example, preferably 2 or more and 1000 or less. The first internal electrodes 16a and the second internal electrodes 16b may each have any thickness without particular limitation, but the thickness is preferably about 0.3 μm or greater and about 6.0 μm or less, for example.

In the present example embodiment, the first counter electrode portion 22a of the first internal electrode 16a and the second counter electrode portion 22b of the second internal electrode 16b face each other with the inner dielectric layer 14a interposed therebetween, such that capacitance is generated, and the characteristics of the capacitor are provided.

### External Electrode

The external electrode 30 includes a plurality of external electrodes 30 connected to the first internal electrodes 16a or the second internal electrodes 16b. Specifically, the external electrodes 30 include a first external electrode 30a, a second external electrode 30b, a third external electrode 30c, and a fourth external electrode 30d.

The first external electrode 30a is disposed on the third surface 12c and connected to the first internal electrodes 16a. The first external electrode 30a may also be disposed on a portion of the first surface 12a, a portion of the second surface 12b, a portion of the fifth surface 12e, and a portion of the sixth surface 12f.

The second external electrode 30b is disposed on the fourth surface 12d and connected to the first internal electrodes 16a. The second external electrode 30b may also be disposed on a portion of the first surface 12a, a portion of the second surface 12b, a portion of the fifth surface 12e, and a portion of the sixth surface 12f.

The third external electrode 30c is disposed on the fifth surface 12e and connected to the second internal electrodes 16b. The third external electrode 30c may also be disposed on a portion of the first surface 12a and a portion of the second surface 12b.

The fourth external electrode 30d is disposed on the sixth surface 12f and connected to the second internal electrodes 16b. The fourth external electrode 30d may also be disposed on a portion of the first surface 12a and a portion of the second surface 12b.

Each of the first external electrode 30a, the second external electrode 30b, the third external electrode 30c, and the fourth external electrode 30d preferably includes, for example, a base electrode layer 32, a lower plating layer 34, and an upper plating layer 36.

In other words, the first external electrode 30a preferably includes a first base electrode layer 32a, a first lower plating layer 34a, and a first upper plating layer 36a. The second external electrode 30b preferably includes a second base electrode layer 32b, a second lower plating layer 34b, and a second upper plating layer 36b. The third external electrode 30c preferably includes a third base electrode layer 32c, a third lower plating layer 34c, and a third upper plating layer 36c. The fourth external electrode 30d preferably includes a fourth base electrode layer 32d, a fourth lower plating layer 34d, and a fourth upper plating layer 36d.

The base electrode layer 32 includes at least one of, for example, a baked layer, a conductive resin layer, a thin film layer, or the like.

First, a case where the base electrode layer 32 includes a baked layer will be described. The baked layer includes a metal component and a glass component. The glass component includes at least one of, for example, B, Si, Ba, Mg, Al, Li, or the like. The metal component of the baked layer includes, for example, at least one of Cu, Ni, Ag, Pd, a Ag—Pd alloy, Au, or the like. Furthermore, the baked layer may include a plurality of layers.

The baked layer is formed by applying a conductive paste including the glass component and the metal component to multilayer body 12, and baking the applied conductive paste. The baked layer is formed by firing a multilayer chip including the internal electrodes 16 and the dielectric layers 14 concurrently with the conductive paste applied to the multilayer chip. Alternatively, the baked layer may be formed by baking the conductive paste applied to the multilayer body 12 obtained by firing the multilayer chip including the internal electrodes 16 and the dielectric layers 14. In the case of firing the multilayer chip including the internal electrodes 16 and the dielectric layers 14 concurrently with the conductive paste applied to the multilayer chip, it is preferable to add a dielectric component instead of the glass component or to add both of the dielectric component and the glass component to form the baked layer.

A first baked layer is formed on the third surface 12c, and a second baked layer is formed on the fourth surface 12d. Each of the first and second baked layers preferably has, in a center portion in the lamination direction x connecting the first surface 12a and the second surface 12b, a thickness (end surface center thickness) of, for example, about 5 μm or greater and about 55 μm or less in the first direction y connecting the third surface 12c and the fourth surface 12d.

In the case where the base electrode layer (baked layer) is also disposed on a portion of the first surface 12a or a portion of the second surface 12b, the first baked layer on the first surface 12a or the second surface 12b and the second baked layer on the first surface 12a or the second surface 12b preferably have, in a center portion in the first direction y connecting the third surface 12c and the fourth surface 12d, a thickness of, for example, about 1 μm or greater and about 30 μm or less in the lamination direction x connecting the first surface 12a and the second surface 12b.

Next, a case where the base electrode layer 32 includes a conductive resin layer will be described. The conductive resin layer may be disposed on a baked layer so as to cover the baked layer, or may be disposed directly on the multilayer body 12 without the baked layer. The conductive resin layer may completely cover the baked layer or may partially cover the baked layer. Furthermore, the conductive resin layer may include a plurality of layers.

The conductive resin layer includes, for example, a thermosetting resin and a metal. Due to including the thermosetting resin, the conductive resin layer is more flexible than a plating film and a baked layer defined by a fired product of a conductive paste, for example. For this reason, the conductive resin layer defines and functions as a buffer layer, making it possible to prevent cracks from forming in the multilayer ceramic capacitor 10 even when a physical impact or an impact due to a thermal cycle is applied to the multilayer ceramic capacitor 10.

Examples of the metal included in the conductive resin layer include Ag, Cu, Ni, Sn, Bi, or an alloy including one or more of them. Alternatively, for example, a metal powder including a surface coated with Ag can be used. In the case of using a metal powder including a surface coated with Ag, a metal powder of, for example, Cu, Ni, Sn, or Bi or an alloy powder thereof may be used. A reason for using the Ag-coated conductive metal powder as the conductive metal is that Ag is suitable for an electrode material because it has the lowest specific resistance among metals, and is a noble metal that is not oxidizable and has high weather resistance. Furthermore, an inexpensive metal can be used as the base material while the characteristics of Ag are maintained.

Additionally, Cu or Ni subjected to an antioxidant treatment can be used as the metal included in the conductive resin layer. A metal powder with a surface coated with Sn, Ni, or Cu, for example, can be used as the metal included in the conductive resin layer. In the case of using such a metal powder with a surface coated with Sn, Ni, or Cu, for example, the metal powder of Ag, Cu, Ni, Sn, or Bi, or an alloy powder thereof may be used.

The metal included in the conductive resin layer is mainly responsible for the electrical conductivity of the conductive resin layer. Specifically, the conductive filler particles in contact with each other provide conduction paths in the conductive resin layer.

The metal included in the conductive resin layer may have a spherical shape, a flat shape, or the like, but it is preferable to use a mixture of a spherical metal powder and a flat metal powder.

Examples of the resin included in the conductive resin layer include various known thermosetting resins such as, for example, an epoxy resin, a phenol resin, a urethane resin, a silicone resin, a polyimide resin, or the like. Among them, the epoxy resin excellent in heat resistance, moisture resistance, adhesion, etc. is one of the more preferable resins.

The conductive resin layer preferably includes a curing agent together with the thermosetting resin. In a case of using, for example, an epoxy resin as a base resin, various known compounds such as, for example, a phenol-based compound, an amine-based compound, an acid anhydride-based compound, an imidazole-based compound, an active ester-based compound, an amide-imide-based compound, or the like can be used as the curing agent for the epoxy resin.

Preferably, the conductive resin layer has a thickness of, for example, about 5 μm or greater and about 50 μm or less in its thickest portion.

Next, a case where the base electrode layer 32 includes a thin film layer will be described. The thin film layer may be provided on the surface of the multilayer body 12. The thin film layer provided as the base electrode layer 32 is formed by a thin film forming method such as sputtering or vapor deposition, for example. The thin film layer is a layer made of deposited metal particles and having a thickness of, for example, about 1 μm or less.

### Lower Plating Layer

The lower plating layer 34 includes a first lower plating layer 34a covering the first base electrode layer 32a, a second lower plating layer 34b covering the second base electrode layer 32b, a third lower plating layer 34c covering the third base electrode layer 32c, and a fourth lower plating layer 34d covering the fourth base electrode layer 32d.

The lower plating layer 34 includes, for example, at least one of Cu, Ni, Sn, Ag, Pd, a Ag—Pd alloy, Au, or the like.

The lower plating layer 34 preferably includes Ni plating. In the case where the lower plating layer 34 includes Ni plating, the base electrode layer 32 can be prevented from being eroded by solder when the multilayer ceramic capacitor 10 is mounted.

The lower plating layer 34 preferably has a thickness of, for example, about 1 μm or greater and about 8 μm or less.

### Upper Plating Layer

The upper plating layer 36 includes a first upper plating layer 36a covering the first lower plating layer 34a, a second upper plating layer 36b covering the second lower plating layer 34b, a third upper plating layer 36c covering the third lower plating layer 34c, and a fourth upper plating layer 36d covering the fourth lower plating layer 34d.

The upper plating layer 36 includes, for example, at least one of Cu, Ni, Sn, Ag, Pd, a Ag—Pd alloy, Au, or the like.

The upper plating layer 36 preferably includes, for example, Sn plating. In the case where the upper plating layer 36 includes Sn plating, solder wettability at the time of mounting the multilayer ceramic capacitor 10 can be improved, thus facilitating the mounting.

The upper plating layer 36 preferably has a thickness of, for example, about 1 μm or greater and about 8 μm or less.

A dimension in the first direction y of the multilayer ceramic capacitor 10 including the multilayer body 12 and the external electrodes 30 is defined as an L dimension. The L dimension is, for example, preferably about 0.51 mm or greater and about 0.69 mm or less. A dimension in the second direction z of the multilayer ceramic capacitor 10 including the multilayer body 12 and the external electrodes 30 is defined as a W dimension. The W dimension is, for example, preferably about 0.21 mm or greater and about 0.39 mm or less. A dimension in the lamination direction x of the multilayer ceramic capacitor 10 including the multilayer body 12 and the external electrodes 30 is defined as a dimension T. The T dimension is, for example, preferably about 0.05 mm or greater and about 0.55 mm or less. Even though the multilayer ceramic capacitor 10 is smaller than the conventional multilayer ceramic capacitor, the above-described configuration makes it possible to reduce the likelihood of deterioration of insulation resistance due to moisture infiltration while reducing the likelihood of a decrease in capacitance due to contact failure between the second internal electrodes 16b and the third external electrode 30c and contact failure between the second internal electrodes 16b the fourth external electrode 30d.

### 2. Method of Manufacturing Multilayer Ceramic Capacitor

An example of a method of manufacturing the multilayer ceramic capacitor 10 according to an example embodiment of the present invention will be described below.

First, dielectric sheets and a conductive paste for forming internal electrodes are prepared. The dielectric sheets and the conductive paste for forming internal electrodes include a binder and a solvent. A known binder and a known solvent can be used.

Next, the conductive paste for forming internal electrode is printed in a predetermined pattern on the dielectric sheets by, for example, screen printing, gravure printing, inkjet printing, or the like. Consequently, the dielectric sheets including thereon a pattern corresponding to the first internal electrode and the dielectric sheets including thereon a pattern corresponding to the second internal electrode are prepared. In this step, the second regions 42 (the third extension electrode portion 24c and the fourth extension electrode portion 24d) of the second internal electrode 16b are made thinner than the first region 40 (the second counter electrode portion 22b) of the second internal electrode 16b. Thereafter, the dielectric sheets including the first internal electrode printed thereon and the dielectric sheets including the second internal electrode printed thereon are laminated to form a portion to become the inner layer portion 18.

Next, a predetermined number of dielectric sheets without a printed internal electrode pattern are laminated to form a portion to become the first main surface-side outer layer portion 20a adjacent to the first surface 12a. Thereafter, the portion to become the inner layer portion 18, which has been prepared in the above-described manner, is laminated. Moreover, a predetermined number of dielectric sheets without a printed internal electrode pattern are laminated over the portion to become the inner layer portion 18, this forming a portion to become the second main surface-side outer layer portion 20b adjacent to the second surface 12b. In this manner, a multilayer sheet is prepared.

Next, the multilayer sheet is pressed in the lamination direction by, for example, isostatic pressing or the like, thus producing a multilayer block.

Subsequently, the multilayer block is cut into a predetermined size so that multilayer chips are produced. In this step, the corners and ridges of the multilayer chips may be rounded by, for example, barrel polishing or the like.

Next, the multilayer chips are fired so that the multilayer bodies 12 are produced. The firing temperature is, for example, preferably about 900° C. or higher and about 1400° C. or lower, although it depends on the ceramic and the materials of the internal electrodes.

The first base electrode layer 32a of the first external electrode 30a and the second base electrode layer 32b of the second external electrode 30b are respectively formed on the third surface 12c and the fourth surface 12d of the multilayer body 12 obtained by firing. The third base electrode layer 32c of the third external electrode 30c and the fourth base electrode layer 32d of the fourth external electrode 30d are respectively formed on the fifth surface 12e and the sixth surface 12f of the multilayer body 12 obtained by firing.

In the case of forming a baked layer as the base electrode layer 32, a conductive paste including a glass component and a metal component is applied and then baked, thus forming the base electrode layer 32.

More specifically, first, the third base electrode layer 32c of the third external electrode 30c and the fourth base electrode layer 32d of the fourth external electrode 30d are respectively formed on the fifth surface 12e and the sixth surface 12f of the multilayer body 12 obtained by firing.

Here, the third base electrode layer 32c and the fourth base electrode layer 32d can be formed by various methods. For example, a method including extruding a conductive paste through a slit to apply the conductive paste can be used. In this method, by increasing an amount of the conductive paste to be extruded, the third base electrode layer 32c and the fourth base electrode layer 32d can be formed on the fifth surface 12e and the sixth surface 12f, respectively, and further on a portion of the first surface 12a and a portion of the second surface 12b.

The third base electrode layer 32c and the fourth base electrode layer 32d can be formed by, for example, a roller transfer method. In the case of the roller transfer method, the third base electrode layer 32c and the fourth base electrode layer 32d can be formed not only on the fifth surface 12e and the sixth surface 12f but also on a portion of the first surface 12a and a portion of the second surface 12b by increasing the pressing pressure during roller transfer.

Next, the first base electrode layer 32a of the first external electrode 30a and the second base electrode layer 32b of the second external electrode 30b are respectively formed on the third surface 12c and the fourth surface 12d of the multilayer body 12 obtained by firing.

Here, the first base electrode layer 32a and the second base electrode layer 32b can be formed by various methods. For example, a method such as dipping can be used so that the first base electrode layer 32a and the second base electrode layer 32b are formed on the third surface 12c and the fourth surface 12d, respectively, and further extend onto a portion of the first surface 12a, a portion of the second surface 12b, a portion of the fifth surface 12e, and a portion of the sixth surface 12f.

In the present example embodiment, the first base electrode layer 32a and the second base electrode layer 32b are baked after the third base electrode layer 32c and the fourth base electrode layer 32d are baked. However, the first base electrode layer 32a, the second base electrode layer 32b, the third base electrode layer 32c, and the fourth base electrode layer 32d may be baked at the same time.

In the case of forming a conductive resin layer as the base electrode layer 32, the conductive resin layer can be formed by the following method. The conductive resin layer may be formed on a surface of a baked layer, or may be formed directly on the multilayer body as a single layer without the baked layer.

For example, the conductive resin layer is formed by a method including applying a conductive resin paste including a thermosetting resin and a metal onto the baked layer or the multilayer body, and performing a heat treatment at a temperature of about 250° C. or higher and about 550° C. or lower to thermally cure the resin. In this example method, the heat treatment is preferably performed in, for example, a N₂ atmosphere. In order to prevent scattering of the resin and oxidation of the metal component, the oxygen concentration is, for example, preferably lowered to about 100 ppm or less.

The conductive resin paste can be applied by, for example, a method including extruding the conductive paste through a slit or a roller transfer method, as in the case of forming the baked layer as the base electrode layer 32.

Thereafter, for example, the lower plating layer 34 is formed on the base electrode layer 32 and the surface of the multilayer body 12, and the upper plating layer 36 is formed so as to cover the lower plating layer 34. More specifically, a Ni plating layer is formed as the lower plating layer 34 on the base electrode layer 32. Thereafter, a Sn plating layer is formed as the upper plating layer 36 on the surface of the lower plating layer 34. The plating may be performed by either electrolytic plating or electroless plating. However, electroless plating requires pretreatment with a catalyst or the like in order to increase the plating deposition rate, and has a disadvantage that the process becomes complicated. Therefore, in general, electrolytic plating is preferred.

In the above-described manner, the multilayer ceramic capacitor 10 illustrated in FIG. 1 can be manufactured.

### 3. Experimental Example

Multilayer ceramic capacitors were prepared in accordance with the above-described example of a manufacturing method, and were evaluated by way of a moisture resistance test. The multilayer ceramic capacitors prepared as Examples had specifications described below. As shown in Table 1, the prepared samples of Examples 1 to 7 included the second internal electrodes 16b in which the first region 40 and the second regions 42 had different thicknesses in the lamination direction x. Multilayer ceramic capacitors prepared as a Comparative Example included second internal electrodes in which a first region and second regions had the same thickness in the lamination direction x.

### (1) Multilayer Ceramic Capacitors as Examples and Comparative Example

(a) Dimensions of multilayer ceramic capacitor
(i) Dimension (T) in the lamination direction x: about 0.30±0.09 mm
(ii) Dimension (L) in the first direction y: about 0.60±0.09 mm
(iii) Dimension (W) in the second direction z: about 0.30±0.09 mm
(b) Main component of the dielectric layers: BaTiO₃
(c) Main component of the internal electrodes: Ni
(d) Capacitance: about 1 μF
(e) Structure of the external electrodes
(i) Base electrode layer: baked layer including a conductive metal (Cu) and a glass component
(ii) Lower plating layer: Ni plating layer
(iii) Upper plating layer: Sn plating layer

### (2) Test Method and Measurement Method

First, the multilayer ceramic capacitors were mounted on a wiring board using solder, and the insulation resistance value of each multilayer ceramic capacitor was measured. Thereafter, the multilayer ceramic capacitors mounted on the wiring board were placed in a high-temperature and high-humidity vessel. In an environment of a temperature of about 85° C. and a relative humidity of about 85% RH, the multilayer ceramic capacitors were maintained for about 1000 hours in a state in which a DC current of about 4 V was applied between the first external electrode and the second external electrode. The insulation resistance value of each multilayer ceramic capacitor after the moisture resistance test was measured. When the insulation resistance value after the moisture resistance test was lower by one digit or more than the insulation resistance value before the moisture resistance test, the multilayer ceramic capacitor is determined to be no good (NG), and an NG ratio was calculated according to the following formula: (the number of NG capacitors/77)×100. The capacitance was measured using an LCR meter E4890A manufactured by Agilent Technologies, Inc., and calculated. The measurement was performed under the conditions of about 1 kHz and about 0.5 Vrms.

Table 1 shows the results of the moisture resistance test of the multilayer ceramic capacitors prepared as Examples and Comparative Example.

TABLE 1

| | Comparative | | | | | | | |
|---|---|---|---|---|---|---|---|---|
| | Example | Examaple 1 | Examaple 2 | Examaple 3 | Examaple 4 | Examaple 5 | Examaple 6 | Examaple 7 |
| t1: Thickness of first region | 0.43 | 0.43 | 0.43 | 0.43 | 0.43 | 0.43 | 0.43 | 0.43 |
| in lamination direction (μm) | | | | | | | | |
| t2: Thickness of second region | 0.43 | 0.39 | 0.35 | 0.30 | 0.17 | 0.09 | 0.04 | 0.02 |
| in lamination direction (μm) | | | | | | | | |
| t2/t1 | 1.0 | 0.9 | 0.8 | 0.7 | 0.4 | 0.2 | 0.1 | 0.0 |
| Number of [symbol] capacitors | 20 | 8 | 0 | 0 | 0 | 0 | 0 | 0 |
| [symbol] ratio (%) | 26 | 10 | 0 | 0 | 0 | 0 | 0 | 0 |
| Capacitance (μ [symbol] ) | 1.00 | 1.00 | 1.00 | 1.00 | 1.00 | 1.00 | 0.52 | 0.13 |

[symbol]

indicates data missing or illegible when filed

As shown in Table 1, the samples of Examples 1 to 7 demonstrated that making the thickness (t2) in the lamination direction x of the second regions 42 smaller than the thickness (t1) in the lamination direction x of the first region 40 reduces the moisture infiltration path in size, and makes it possible to reduce or prevent deterioration of insulation resistance due to moisture infiltration. In particular, the samples of Examples 2 to 7 demonstrated that setting the thickness (t2) in the lamination direction x of the second regions 42 and the thickness (t1) in the lamination direction x of the first region 40 to satisfy t2 about 0.8t1 makes it possible to reduce or prevent deterioration of insulation resistance due to moisture infiltration between the third external electrode 30c and the second internal electrodes 16b and moisture infiltration between the fourth external electrode 30d and the second internal electrodes 16b. Furthermore, the samples of Examples 1 to 5 demonstrated that setting the thicknesses t1 and t2 to satisfy about 0.2t1≤t2 makes it possible to reduce or prevent a decrease in capacitance due to contact failure between the third external electrode 30c and the second internal electrodes 16b and contact failure between the fourth external electrode 30d and the second internal electrodes 16b.

The present invention is not limited to the example embodiments described above. Specifically, various changes can be made to the above-described example embodiments in terms of the mechanism, shape, material, quantity, position, arrangement, and the like without departing from the technical idea and scope of the present invention, and such changes are encompassed in the present invention.

In the example embodiment described above, each second internal electrode 16b includes the first region 40 located inside the inner layer portion and the second regions 42 extending from the first region 40 toward the fifth surface 12e and the sixth surface 12f of the multilayer body 12, respectively, and the second regions 42 are thinner in the lamination direction x than the first region 40. However, the present invention is not limited to this configuration, and the same or substantially the same advantageous effects can be obtained by a configuration in which each first internal electrode 16a includes a region located inside the inner layer portion and regions extending from the region inside the inner layer portion toward the third surface 12c and the fourth surface 12d of the multilayer body 12, respectively, and the regions extending toward the third surface 12c and the fourth surface 12d are thinner in the lamination direction x than the region inside the inner layer portion.

Example embodiments of the present invention relate to multilayer ceramic capacitor, and are applicable as a multilayer ceramic capacitors each able to reduce the likelihood of deterioration of insulation resistance due to moisture infiltration.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first surface and a second surface opposed to each other in a lamination direction, a third surface and a fourth surface opposed to each other in a first direction orthogonal or substantially orthogonal to the lamination direction, and a fifth surface and a sixth surface opposed to each other in a second direction orthogonal or substantially orthogonal to the lamination direction and the first direction;
a first external electrode on the third surface of the multilayer body;
a second external electrode on the fourth surface of the multilayer body;
a third external electrode on the fifth surface of the multilayer body; and
a fourth external electrode on the sixth surface of the multilayer body; wherein
the multilayer body includes:
an inner layer portion; and
two outer layer portions sandwiching the inner layer portion in the lamination direction;
the inner layer portion includes:
an inner dielectric layer;
a first internal electrode including ends in the first direction exposed at the third surface and the fourth surface, respectively; and
a second internal electrode including ends in the second direction exposed at the fifth surface and the sixth surface, respectively;
the second internal electrode includes:
a first region located inside the multilayer body; and
second regions extending from the first region toward the fifth surface and the sixth surface, respectively; and
the second regions is thinner in the lamination direction than the first region.

2. The multilayer ceramic capacitor according to claim 1, wherein
the first region has a thickness t1 in the lamination direction;
the second regions have a thickness t2 in the lamination direction; and
the thicknesses t1 and t2 satisfy the following relationship: about 0.2t1≤t2≤about 0.8t1.

3. The multilayer ceramic capacitor according to claim 1, wherein
the multilayer ceramic capacitor has a dimension L in a direction connecting the third surface and the fourth surface, and a dimension W in a direction connecting the fifth surface and the sixth surface;
the dimension L is about 0.51 mm or greater and about 0.69 mm or less; and
the dimension W is about 0.21 mm or greater and about 0.39 mm or less.

4. The multilayer ceramic capacitor according to claim 1, wherein the inner dielectric layer includes BaTiO₃, CaTiO₃, SrTiO₃, or CaZrO₃ as a main component.

5. The multilayer ceramic capacitor according to claim 4, wherein the inner dielectric layer includes a Mn compound, an Fe compound, a Cr compound, a Co compound, or a Ni compound as a subcomponent.

6. The multilayer ceramic capacitor according to claim 1, wherein a thickness of the inner dielectric layer is about 0.3 μm or greater and about 6.0 μm or less.

7. The multilayer ceramic capacitor according to claim 1, wherein the first and second internal electrodes includes Ni, Cu, Ag, Pd, or Au, or an alloy including at least one of Ni, Cu, Ag, Pd, or Au.

8. The multilayer ceramic capacitor according to claim 1, wherein each of the first and second internal electrodes includes Sn.

9. The multilayer ceramic capacitor according to claim 1, wherein a thickness of each of the first and second internal electrodes is about 0.3 μm or greater and about 6.0 μm or less.

10. The multilayer ceramic capacitor according to claim 1, wherein each of the first, second, third, and fourth external electrodes includes a base electrode layer, a lower plating layer, and an upper plating layer.

11. The multilayer ceramic capacitor according to claim 10, wherein the base electrode layer includes at least one of a baked layer, a conductive resin layer, or a thin film layer.

12. The multilayer ceramic capacitor according to claim 10, wherein the base electrode layer includes a metal component and a glass component.

13. The multilayer ceramic capacitor according to claim 12, wherein the glass component includes at least one of B, Si, Ba, Mg, Al, or Li.

14. The multilayer ceramic capacitor according to claim 12, wherein the metal component includes at least one of Cu, Ni, Ag, Pd, a Ag—Pd alloy, or Au.

15. The multilayer ceramic capacitor according to claim 10, wherein the lower plating layer includes at least one of Cu, Ni, Sn, Ag, Pd, a Ag—Pd alloy, or Au.

16. The multilayer ceramic capacitor according to claim 10, wherein a thickness of the lower plating layer is about 1 μm or greater and about 8 μm or less.

17. The multilayer ceramic capacitor according to claim 10, wherein the upper plating layer includes at least one of Cu, Ni, Sn, Ag, Pd, an Ag—Pd alloy, or Au.

18. The multilayer ceramic capacitor according to claim 10, wherein a thickness of the upper plating layer is about 1 μm or greater and about 8 μm or less.
